(19) United States
(12) Patent Application Publication
(10) Pub. No.: US 2022/0174674 A1
(43) Pub. Date: Jun. 2, 2022

(54) METHOD FOR SELECTING A CHANNEL IN A WIRELESS ACCESS POINT DEVICE OF A COMMUNICATION NETWORK AND ASSOCIATED WIRELESS ACCESS POINT DEVICE

(71) Applicant: SAGEMCOM BROADBAND SAS, Rueil Malmaison (FR)

(72) Inventors: Samira MAPAR, Rueil Malmaison (FR); Serge CONTAL, Rueil Malmaison (FR); Elyes BEN HAMIDA, Rueil Malmaison (FR)

(73) Assignee: SAGEMCOM BROADBAND SAS, Rueil Malmaison (FR)

(21) Appl. No.: 17/538,584

(22) Filed: Nov. 30, 2021

(30) Foreign Application Priority Data
Nov. 30, 2020 (FR) 2012397

(51) Int. Cl. H04W 72/04; H04W 48/16

(52) U.S. Cl. CPC H04W 72/0453; H04W 84/12; H04W 48/16; H04W 72/0486

(57) ABSTRACT

A method for selecting a wireless communication channel between a wireless access point of a communication network and a station, the method being executed in the wireless access point device of the communication network, the method including locally obtaining, from the wireless access point, at least a first information item representing a first electromagnetic environment within range of the wireless access point, obtaining, from a remote server, at least a second information item representing a second electromagnetic environment around the wireless access point, then selecting the communication channel by virtue of the first information item and the second information item, and configuring a radio interface of the wireless access point to implement wireless communications with the station in the selected channel. Also, a wireless access point device executing this method.

### TECHNICAL FIELD

The present invention relates to the selection and allocation of communication channels in one or more wireless communication networks, particularly in a regulated radio environment. The invention more specifically relates to the selection of a channel from among a plurality of channels, some of which are likely to be used by radar-type equipment.

### PRIOR ART

The implementation of Wireless Local Area Networks (WLANs) offers great flexibility for users of mobile communication devices, such as computers, tablets, smartphones, connected objects, etc. Such WLAN networks are established, for example, by wireless access point devices integrated in Residential GateWays (RGW) provided by telecommunication operators, but also via devices for extending the range of such a network, or even via devices connected to the network, such as a digital television decoder, for example. Thus, many wireless access point devices can coexist in the same local communication network, which also comprises optional wired connection points.

Frequency bands (or channels) in the “5 GHz” band are shared between uses for wireless communications in WLAN-type networks and priority uses such as the use of weather radar, civil aviation radar or even military radar.

To this end, a “DFS” (Dynamic Frequency Selection) function has been introduced into the IEEE802.11h standard and the ETSI BRAN HIPERLAN/2 standard, both of which regulate the wireless communication applications that are respectively compatible with them. This Dynamic Frequency Selection (DFS) function therefore refers to mechanisms that allow unlicensed peripherals, in particular those operating outside, to share the 5 GHz frequency bands allocated to radar-type systems, without causing interference on these radars. Thus, when a wireless communication device, such as a wireless access point device in a communication network, is configured to use a channel that is likely to be used for a priority radar application, commonly called a “DFS channel”, the device must ensure that the channel is available. In other words, the device must search the channel for the presence of certain characteristic signals representing radar operation. The duration of the search implemented prior to the use of a channel depends on the type of channel and on the listening method (scanning). When listening is continuous, it must last from 1 to 10 minutes at least, depending on the regulations and the frequency of the channel. If listening is implemented on one channel whilst transmitting on another channel, it must last between 6 minutes and 1 hour, depending on the case. Again, according to the regulations, when the DFS function is enabled in a wireless access point device, the device will monitor the frequency that it uses to detect radar signals. If radar signals are detected on a channel during use, it will have to leave this channel and immediately switch to another channel. In addition, the channel on which the radar are detected cannot be used for a predetermined time (for example, 30 minutes).

When listening, the radio interface is therefore unavailable or offers significantly reduced performance capabilities.

In order to meet the requirement for radar detection, some wireless communication equipment suppliers provide the radio interfaces with a second receiver dedicated to listening to DFS channels in order to detect signals characteristic of the use of a radar. However, this solution adds complexity and cost.

Another solution exists whereby a communication network management server centralizes information from numerous wireless access point devices and selects the channels to be used by the various access point devices.

However, the situation can still be improved further.

### DISCLOSURE OF THE INVENTION

The aim of the invention is to provide an optimized method for selecting a DFS channel in a wireless access point device of a communication network.

To this end, a method is proposed for selecting a wireless communication channel, between a wireless access point device of a communication network and a station, the method being executed in the wireless access point device of said communication network (1), the method comprising:
locally obtaining, from said wireless access point device, at least a first information item, representing a first electromagnetic environment within range of said wireless access point device;
obtaining, from a remote server, at least a second information item, representing a second electromagnetic environment around said wireless access point device;
selecting said communication channel by virtue of at least said first information item and said second information item;
configuring a radio interface of said wireless access point device to implement wireless communications with said station in the selected channel.

Thus, the selection of the channel is neither solely centralized nor solely based on local information measured and/or determined by the access point device. A first advantage is that it is possible to have information that is not directly accessible by the wireless access point device other than by receiving it from a third party device. A second advantage is that in the event of significant variability in the features specific to the environment within electromagnetic range of the access point device, changes in the environment local to the wireless access point device can be taken into account, even if this information is not available to a centralized server. For example, when a channel has just become available and is the only channel that can be used.

A third advantage is that it is possible to take into account structured information following one or more gathering phases, such as, for example, features of an electromagnetic environment combined (superimposed) with a mesh map, such as a map in the form of map tiles with adjustable resolution.

The method according to the invention can also comprise the following features, considered individually or in combination:
said first information item represents a frequency band and the second information item represents at least one level of availability of a wireless communication channel in said frequency band. Thus, it is possible to select, for example, a DFS channel in the 5 GHz band from information centralized by a central server and from locally defined or measured information;
the second information item is included in a list of information relating to various communication channels and each representing at least one level of availability of a wireless communication channel from among several wireless communication channels in said frequency band. Advantageously, a wireless access point device thus can have a list of DFS channels likely to be used, as well as an availability index allowing it to contemplate allocating each of these channels according to an order of priority. For example, the channel that is most likely to be available will be allocated or tested first. If this channel is occupied by a radar or any other priority application, the channel classified in a second position in terms of probability of availability will then be considered and potentially allocated, and so on;
the second information item is obtained from the remote server following the transmission, by the wireless access point device, to the remote server, of a request issued with a view to obtaining at least this second information item. Thus, advantageously, the information available from the remote server centralizing information is only delivered to the wireless access point device if the latter considers it to be useful, which has the effect of preserving the bandwidth between the remote server and the wireless access point device, and therefore more generally the bandwidth in the entire communication network that comprises these devices;
the second environment is defined with reference to one or more location information items of the wireless access point device in a mapped data repository shared between the wireless access point device and the remote server. Advantageously, it is thus possible to superimpose (reference or index) information relating to electromagnetic environments with respect to geographical points so as to establish an electromagnetic map and to be able to determine the presence of an element that cannot be perceived directly by a wireless access point device, since it is not within its range in terms of electromagnetic reception;
at least one channel of the frequency band is defined as being primarily attributable for an application other than wireless communications, in particular for implementing detection by means of radar-type equipment. Advantageously, it is thus possible to manage constraints imposed by regulations relating to DFS channels or even any other constraint on the use of channels in a frequency band making the use of a channel in a frequency band a priority for an application other than wireless communications, for example, communications in a residential context between electronic equipment within a household or a building;
the method comprises at least one step of gathering information representing environments around a plurality of wireless access point devices comprising the wireless access point device and transmitting this information to the central server. Advantageously, the central server then has information that is measured and read directly by a wireless access point device, which allows, when a large number of wireless access point devices operate in the same way, the centralization and pooling of information relating to channel occupancy or information related to this information for a large geographical area to be optimized;
the method comprises a plurality of steps of gathering information representing environments around a plurality of wireless access point devices comprising said wireless access point device and, at least some of the gathering steps are prior to the selecting step and some of the gathering steps are subsequent to the selecting step. Thus, information transfer operations regularly occur in relation to the central server, which makes the updating of the centralized information regular and confers greater relevance to the latter with a view to subsequent use.

A further aim of the invention is a wireless access point device of a communication network, the device comprising electronic and/or radio circuits configured for:
locally obtaining, from the wireless access point device, at least a first information item, representing a first electromagnetic environment within range of the wireless access point device;
obtaining, from a remote server, at least a second information item, representing a second electromagnetic environment around the wireless access point device;
selecting said communication channel by virtue of at least the first information item and the second information item;
configuring a radio interface of the wireless access point device to implement wireless communications with the station in the selected channel.

Advantageously, such a wireless access point device can thus implement channel selection, allocation and configuration with precise knowledge of its electromagnetic environment, in terms of channel occupancy and neighbouring devices, within the perimeter corresponding to its range in terms of electromagnetic reception, and even further.

A further aim of the invention is a server in a communication network, called “remote server”, the server comprising electronic and/or radio circuits configured for:
receiving, from at least one wireless access point device connected to the communication network, information representing one or more environments around one or more wireless access point devices comprising the wireless access point device;
sending, optionally in response to a request, at least one information item to a wireless access point device representing an electromagnetic environment around the wireless access point device.

The invention also relates to a system in a communication network comprising a wireless access point device as previously described and a server, called remote server, as described above.

Finally, the aim of the invention is a computer program product comprising program code instructions for executing the steps of the aforementioned method, when the program is executed by a processor, as well as an information storage medium device comprising such a computer program product.

### BRIEF DESCRIPTION OF THE DRAWINGS

The aforementioned features of the invention, as well as other features, will become more clearly apparent from reading the following description of at least one embodiment, said description being provided with reference to the appended drawings, in which:

FIG. 1 shows a communication network comprising a plurality of wireless access point devices configured to execute a method for selecting a DFS communication channel according to one embodiment;

FIG. 2 is a flowchart showing steps of a method for selecting a communication channel, executed in a wireless access point device shown in FIG. 1;

FIG. 3 is a block diagram showing an architecture of a wireless access point device according to one embodiment; and

FIG. 4 is a block diagram showing an architecture of a server of the communication network shown in FIG. 1 and used by the method described in FIG. 2.

### DETAILED DESCRIPTION OF EMBODIMENTS

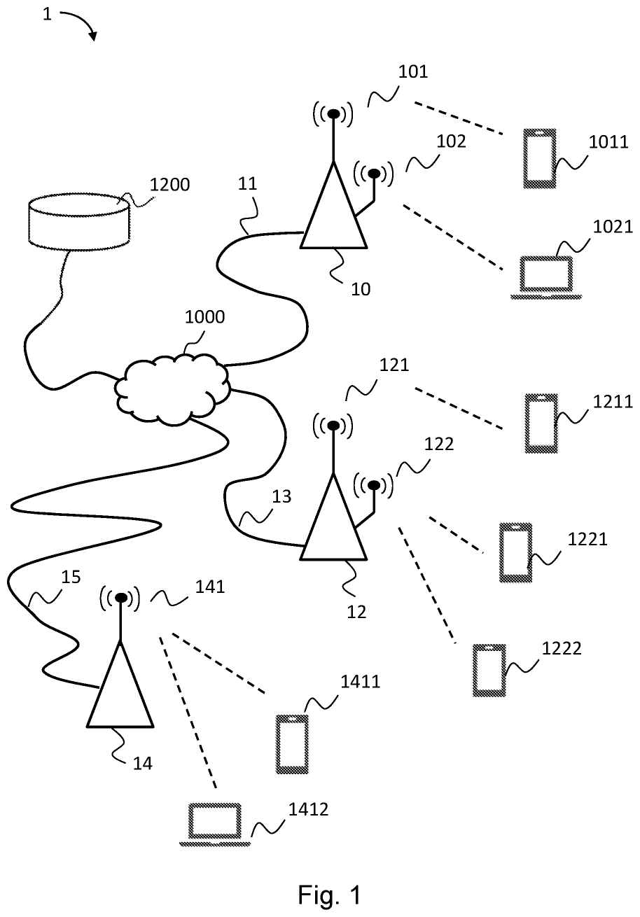

FIG. 1 schematically shows a communication network 1 comprising a Wide Area Network (WAN) 1000 to which electronic devices such as smartphones 1011, 1211, 1221, 1222, 1411 and laptops 1021 and 1412 are connected. Each of the electronic devices is connected to the wide area network 1000 by means of network communication gateway type equipment, commonly called a “network gateway”. Such equipment is conventionally configured to interconnect a wide area network and at least one Local Area Network (LAN) and commonly comprises wired and wireless connection interfaces for connecting electronic devices. Thus, the smartphone 1011, is connected to the wide area network 1000 by means of network gateway type equipment (not shown) comprising a wireless access point device 10, which wireless access point device 10 comprises a radio interface 101 and a radio interface 102. Similarly, the laptop 1021 is connected to the wide area network 1000 by means of the access point device 10, and therefore by means of the same network gateway as the smartphone 1011. The smartphone 1011 is connected to the wireless access point device 10 via the radio interface 101 and the laptop 1021 is connected to the wireless access point 10 via the radio interface 102. Throughout the remainder of the description, the terms “access point” and “access point device” are used interchangeably and have the same meaning. According to one embodiment, the wireless access point 10 is configured as a residential access point and can be used as a wireless access point by all compatible electronic devices in a first household. In like manner to what is implemented in the first household, the smartphones 1211, 1221 and 1222 are attached to a second household and connected to the wide area network 1000 by means of an access point 12, included in a network gateway (not shown) that comprises radio interfaces 121 and 122. In this second household, the smartphone 1211 is connected to the wireless access point 12 via the radio interface 121 and the smartphones 1221 and 1222 are connected to the wireless access point 12 via the radio interface 122. In like manner to what is implemented in the first household and in the second household, the smartphone 1411 and laptop 1412 are attached to a third household and are connected to the wide area network 1000 by means of a network gateway (not shown) that comprises the wireless access point 14, which wireless access point 14 comprises a single radio interface 141. According to alternative embodiments, each of the wireless access point devices 10, 12 and 14 may not be implemented in network gateway equipment, but outside such equipment and connected thereto by a wired or wireless link. It does not matter whether or not an access point device among the wireless access point devices 10, 12 or 14 is integrated into another item of equipment such as a gateway, audio-video equipment or a network repeater, for example. According to an alternative embodiment, the wireless access point devices 10, 12 and 14 each can be connected to a network gateway by means of one or more other wireless access point devices. Therefore, the smartphone 1411 and the laptop 1412 are both connected to the wireless access point 14 via the radio interface 141. The smartphone and laptop type electronic devices described above are also referred to as stations in the present description. Of course, other types of stations can be connected to a wireless access point, such as, by way of examples, a printer, an IP camera, a home automation element of the sensor or actuator type, a storage device, etc. The wide area network 1000 comprises a server 1200, called “remote server”, remote from the wireless access points 10, 12, and 14. The server 1200 of the wide area network 1000, although remote from the wireless access points 10, 12 and 14, is configured to be able to communicate with a multitude of wireless access points that are remote from it. This multitude of wireless access points particularly comprises the wireless access points 10, 12 and 14. It should be noted that the network gateways of the first, second and third households respectively comprising the wireless access points 10, 12 and 14 are not shown in FIG. 1 and that only the access points 10, 12 and 14 themselves are shown in FIG. 1. Indeed, the implementation details of the gateways, and more broadly of the network connections 11, 13 and 15 respectively allowing the access points 10, 12 and 14 to be connected to the wide area network 1000, are not useful for a good understanding of the invention described herein.

However, it should be schematically noted that the network connections 11, 13 and 15 each comprising a gateway, which gateway comprises one of the wireless access points 10, 12 or 14, can be of different types. For example, the network connections 11, 13 and 15 each can be implemented as a telephone subscriber line, and the connection uses, for example, ADSL (Asymmetric Digital Subscriber Line) technology, a fibre optic type connection or even a fixed wireless access type link based on 4G and/or 5G access technologies, for example. These examples are not limiting.

Thus, the remote server 1200 is configured to exchange information or data with remote access points and in particular the wireless access points 10, 12 and 14. Symmetrically, the wireless access points 10, 12 and 14 are each configured to exchange information or data with the remote server 1200, which implements, among other things, an information or data server function for remote access points including the wireless access points 10, 12 and 14. According to one embodiment of the invention, the information or data exchanges between the wireless access points 10, 12 and 14 and the remote server 1200 are implemented by virtue of protocols such as, by way of an example, the HTTP protocol (HyperText Transfer Protocol), which is an application-layer protocol and which can operate on any reliable network connection, or even the Message Queuing Telemetry Transport (MQTT), which is designed for exchanges with remote devices when the bandwidth is limited. However, one or more other protocols can be used, provided that they ensure the correct transmission of information. The terms “information” and “data” are to be understood interchangeably herein. Many different types of data can be aggregated in a message using, for example, the JSON (JavaScript Object Notation) format.

According to one embodiment, the wireless access point devices of the communication network 1, including the wireless access point devices 10, 12 and 14, and the remote server 1200 cooperate for the purpose of characterizing first electromagnetic environments around each of the wireless access point devices 10, 12 and 14 of the communication network 1 and second electromagnetic environments, broader than the first electromagnetic environments, and comprising all or part of the latter, or even simply neighbouring the first electromagnetic environments. Thus, an electromagnetic environment defined as being a second electromagnetic environment can comprise all or part of one or more first electromagnetic environments, but not necessarily.

The term “first electromagnetic environment” is to be understood herein as a set of electromagnetic (or radio) occupancy features of a space around a wireless access point device, the features of which can be measured and recorded by this wireless access point itself. The term “second electromagnetic environment” is to be understood herein as a set of electromagnetic (or radio) occupancy features of a space around a wireless access point, some of the features of which optionally can be measured and recorded by this wireless access point, itself, other cannot be measured by this wireless access point. Thus, knowledge of all or part of a second electromagnetic environment around a wireless access point, by this same wireless access point, requires centralization or pooling of the features of this second electromagnetic environment and the transmission of one or more information items representing this second electromagnetic environment, to this wireless access point. Cleverly, the remote server 1200 is configured and used for such centralization and pooling of information representing these features, i.e. information representing the first and second electromagnetic environments respectively located around or close to a wireless access point. Ideally, the pooling of information representing the second electromagnetic environments is such that the remote server 1200 comprises information relating to the environment of all the access points connected to the communication network 1. Advantageously, each of the wireless access points that measures and records features of the electromagnetic environment within its range, that is a first electromagnetic environment, can transmit these features to the remote server 1200 so that said server can sort, process and analyse them and build up information representing second electromagnetic environments that can then be transmitted to a wireless access point affected or potentially affected by this information. The information is stored in a database within the remote server 1200 or within a third party server connected to and accessible from the remote server 1200. According to an alternative embodiment, several remote servers similar to the remote server 1200 can be used, either in parallel to overcome a failure of one of the servers, or in a complementary manner, by operating, for example, each for a predetermined geographical area (for example, one server per region, or per country, or per city, etc.)

The term “electromagnetic occupancy features of a space around a wireless access point” is to be understood as features likely to indicate, for example, whether a frequency band is used in this space, whether a channel of this frequency band is occupied in this space, whether an occupied channel is allocated for wireless communications according to an IEEE 802.11 standard in this space, or even is used by a radar, such as a weather radar, a civil aviation radar, or even a military radar in this space. These features can also indicate whether a channel is abnormally noisy, or disrupted, by an identifiable or unidentifiable source.

According to one embodiment, the remote server 1200 therefore comprises a database of information representing electromagnetic environments of remote wireless access points comprising the wireless access points 10, 12 and 14. Cleverly, the database of the remote server 1200 stores information according to a repository for establishing a map of the wireless access points comprising information representing electromagnetic environments. In other words, the recorded features refer to a map of the wireless access points, i.e. by comprising location information coupled with features representing a first and/or second electromagnetic environment as previously defined. Thus, a wide range of information is stored in the database of the remote server 1200, in addition to that aimed at identifying occupied channels, in particular the occupancy of DFS channels by radar. This related information is, for example, a public WAN IP address of a network gateway to which a wireless access point is connected, a list of wireless access points of a household comprising a given gateway, as well as electronic devices (stations) connected thereto, a list of adjacent wireless networks, in particular networks compatible with an IEEE 802.11 standard. A description of the wireless access points and the stations connected thereto can comprise, for example, the MAC and IP addresses of this equipment, the frequency bands and channels respectively used or that can be used by this equipment, the IEEE 802.11 standards supported by this equipment, an assessment of the bandwidths available via the various wireless links implemented in the household. A description of adjacent wireless networks compatible with an IEEE 802.11 standard can comprise an SSID, one or more MAC addresses, signal level indicators, such as RSSI values. Such information typically represents the constitution of a household in the sense of wireless communications within or adjacent to this household.

Information relating to the occupancy of DFS channels can comprise, for example, lists of time series each comprising timestamp information, a selected frequency band, a selected channel number within a frequency band, a status indicator of a selected channel, for example, assuming a value from among the “free” and “radar detected” values, a type of radar, for example, civil, military, weather, a receiving power of a radar, expressed in dBm, for example. It should be noted that the presence of a radar in a channel can be affected by a reception level higher than a predetermined threshold value, for example, equal to −62.5 dBm, as defined in the ETSI EN 301 893 v2 standard or one of its evolutions, applicable in Europe or according to the Electronic Code of Federal Regulations applicable in the United States. The term “frequency band” is to be interpreted herein in a generic way, i.e. as representing an interval of adjacent frequencies. Thus, a channel in the 5 GHz frequency band is to be interpreted as a narrow frequency band within a broader frequency band.

According to one embodiment of the invention, if some of the information representing first and second electromagnetic environments, present in the database of the remote server 1200, is present as a result of successive information gathering steps implemented by wireless access points of the communication network 1, other information can be entered into the database of the remote server 1200 by another method. For example, information can be gathered by other channels, or by third party services, or external parties and entered into the database of the remote server 1200 manually or automatically. Thus, for example, databases of positions occupied by civil, military or weather radar can be inserted into the database of the remote server 1200. Such information also can be combined with related information intended to define, for example, a usage rate for a particular radar, or periods of typical usage of this radar. For example, a military radar may only be made active for exercise phases and systematically inactivated outside these phases.

Advantageously, the database of the remote server 1200 can comprise information that is all related to each other, for example, the database can form or be included in a platform called “cloud platform” of the same telecommunications operator and can list all the information related to its subscribers. The operator equally could be a service provider using the infrastructures of several telecommunications operators and the common point between the data then would be that they all correspond to data related to the clients of this operator, i.e. data related to their households and the various neighbourhoods of their households.

According to one embodiment of the invention, the information stored in the database of the remote server 1200 is attached to location data, whenever possible. Thus, a cloud platform of an operator advantageously can gather and process information representing electromagnetic environments emitted by the various wireless access points of the various households connected thereto and can process this information by adopting a “crowdsensing” (or participative measures) approach intended to:
build and maintain a mesh map showing the relative position of the wireless access points and/or households to each other;
superimpose this mesh map with the occupancy information of the various channels with respect to radar signal detection.

The radar signal detection information can be, for example, an absence of detection, a detection, a power, transmission features of the radar signals, a timestamp.

Advantageously, it is possible, by virtue of this information, to determine a prioritized list of communication channels to wireless access points, optionally on request from these wireless access points.

According to one embodiment of the invention, prioritized lists of available DFS channels are recurrently transmitted to the various access points. According to an alternative embodiment, and in order to limit network congestion due to the automatic transmission of such information, the prioritized lists are transmitted on request. According to yet another alternative embodiment, lists are regularly transmitted but with a reduced transmission frequency and transmissions in response to a request can be implemented between two automatic transmissions.

Thus, an access point can save considerable time in a method for selecting and allocating a DFS channel, i.e. a channel likely to be occupied by a priority application, such as a detection implemented by means of a radar using this channel.

Another advantage is that such cooperation of a remote server centralizing information and a plurality of wireless access points connected thereto allows the management, configuration and thus the use of wireless equipment (network gateways, network extenders, etc.) to be optimized on the scale of a given territory or a predefined geographical area.

A method for establishing a mesh map by the remote server 1200 can be defined, for example, by determining the geographical position of a wireless access point or a household comprising a wireless access point, when one or more information items representing an electromagnetic environment are transmitted by a wireless access point to the remote server 1200. Thus, the latitude and the longitude of a household can be determined from, for example, the public IP address of the gateway used by the wireless access point. Such locating can be implemented through geolocation services available on the internet, for example, which allow a relatively precise location of a household to be determined. This technique of locating a wireless access point or a household is not always efficient and locating a household also can be determined by triangulation techniques relative to other reference households, the position of which is already known. This is achieved, for example, by virtue of the transmission of lists of wireless networks and access points previously sent to the remote server 1200 by wireless access points. Other information can be used to build the database of the remote server 1200, such as the addresses of the clients of an operator, and the corresponding locating information. From some or all of this locating information, a geocode is determined for each household, so that the data can be geographically referenced (or indexed) in the database of the remote server 1200.

The geocodes can be determined using, for example, the Geohash algorithm that is available in the public domain, or a similar algorithm, which subdivides the surface of the earth into a hierarchical grid. The algorithm that is used then allows a GPS position to be matched with a geocode that uniquely allows a geographical area to be accurately identified (and therefore the surface area) that can be arbitrarily defined according to the length of the defined geocode.

The use of a geocode then allows data to be stored in the database according to their geographical proximity (same geocode prefix) and the accuracy of which can be dynamically adjusted according to the processing to be carried out. Such a mechanism allows households from the same district of a city to be grouped together, in the same building, in the same city or in the same region, for example.

Advantageously, it is thus possible to identify the list of congested DFS channels for each of the definable areas with reference to a geocode or, more broadly, to information representing a geographical situation, or a geographical proximity (in other words, a location). A relevant list of congested DFS channels then can be transmitted to a wireless access point of the communication network 1 by the remote server 1200 implementing cloud platform functions, i.e. pooling knowledge of the occupancy of DFS channels, in order to optimize channel selection operations by the wireless access points of the communication network 1.

Cleverly and according to one embodiment of the invention, a DFS channel availability index is computed from data available in the database of the remote server 1200. Several modes for computing a DFS channel availability index can be used. In the event that DFS channel occupancy information is already available in the database for a given location, or a given geographical area, the availability index of each DFS channel can be computed, for example, as being the average of the observations (or DFS channel status) referenced with a geocode or any information representing a reference geographical proximity of the relevant area. In the event that DFS channel occupancy information for a given area does not yet exist in the database of the remote server 1200, a DFS channel availability index can be determined as being the average of observations referenced for areas adjacent to the relevant area. In one example, adjacent areas are easily identifiable by their respective geocodes, with said geocodes sharing a common location coding portion with the geocode of the relevant area. Thus, a mesh map made up of tiles is such that each area defined with given accuracy (and thus a given surface area) has eight adjacent areas, which each successively represent a north-west area, a north area, a north-east area, a west area, an east area, a south-west area, a south area and a south-east area. For example, if all the aforementioned adjacent areas each have an availability index for a predetermined DFS channel (for example, the DFS channel 100) with a maximum value of 1, then the availability index for this DFS channel 100 in the central, targeted area also has a maximum value of 1. Otherwise, if all the aforementioned adjacent areas each have an availability index for this predetermined DFS channel (always DFS channel 100, for example) with a minimum value of 0, then the availability index of this DFS channel in the central target area also has a minimum value of 0. Finally, if the availability indices of the eight adjacent areas have disparate values, for a given DFS channel, for example, successively 1; 1; 1; 0.6; 0.7; 0.25; 0.3 and 0.4, then the availability index for this channel in the central, targeted area will be equal to the average of these eight values, that is equal to 0.65. According to similar reasoning, an index determination mode, for a given DFS channel, can be defined, for example, so that a value of the index equal to 0.5 for this DFS channel and in a given geographical area, means that this DFS channel is identified as being occupied by a radar in a first adjacent area, and not occupied by a radar in a second adjacent area, with the other adjacent areas not having been scanned yet. Again, by the same reasoning, an index value of 0.66 for a DFS channel in a given geographic area means that this DFS channel is identified as being occupied by a radar in two adjacent areas and not occupied by a radar in a third adjacent area, with the other adjacent areas not having been scanned yet.

Of course, the computation of a channel availability index in a target area (or area of interest) is not limited to the examples described above. For example, depending on the existing distance between reference households for which data is available and the household for which a DFS channel availability index is to be determined, it is possible to interpolate reception measurements of radar signals in order to estimate the power at a specific position, and then to more precisely determine the status of the radar at this position, for example, whether or not the power computed by interpolation is greater than a predetermined threshold value, such as, for example, −62.5 dBm.

For example, if a radio signal originating from a radar is perceived in a channel with a measured power that is greater than −62.5 dBm, then the value of the availability index for that channel will be 0, which means that the channel is unavailable. Conversely, if a radio signal originating from a radar is perceived in a channel with a measured power that is lower than −62.5 dBm, then the value of the availability index for that channel will be 1, which means that the channel is available. The definition of the availability index is set by convention, in an arbitrary manner, and a reverse convention obviously could be used so that an index value of 1 corresponds to an unavailable channel and a value of 0 for this same index corresponds to an available channel. Finally, the availability index computed for a channel reflects the probability of occupancy of a DFS channel. Advantageously, the compared values of the indices of a plurality of DFS channels allow a priority to be established by means of a classified list of DFS channels to be processed according to a priority order by a wireless access point device wishing to allocate a DFS channel in order to implement wireless communications.

For example, a list of channels and associated indices transmitted between the remote server 1200 and a wireless access point in the communication network 1 can be schematically shown as follows:

$$100 \text{:} i = 1 ;$$

$$104 \text{:} i = 1 ;$$

$$108 \text{:} i = 0.8 ;$$

$$112 \text{:} i = 0 ;$$

$$116 \text{:} i = 0 ;$$

where the number (100, 104, etc.) is a channel identifier and i is an availability index, where a maximum value of 1 means that the channel is definitely available and a minimum value of 0 means that the channel is definitely unavailable.

According to one embodiment of the invention, the remote server 1200 transmits, automatically or on request, a list of DFS channels classified by order of availability to all or some of the wireless access points of the communication network 1, so that each of the access points can know which DFS channel is the most likely to be available from among the DFS channels likely to be used by this wireless access point. Advantageously, an access point combines the information it has available, having measured it itself, with the information it has available after receiving it from the remote server 1200. Thus, the method for selecting a DFS channel by a wireless access point is hybrid, in that it is neither solely based on centralized information, nor solely based on local information. The variability of the local information can be increased, for example, with respect to the information obtained from the remote server 1200, which pools information from all or some of the wireless access points of the communication network 1.

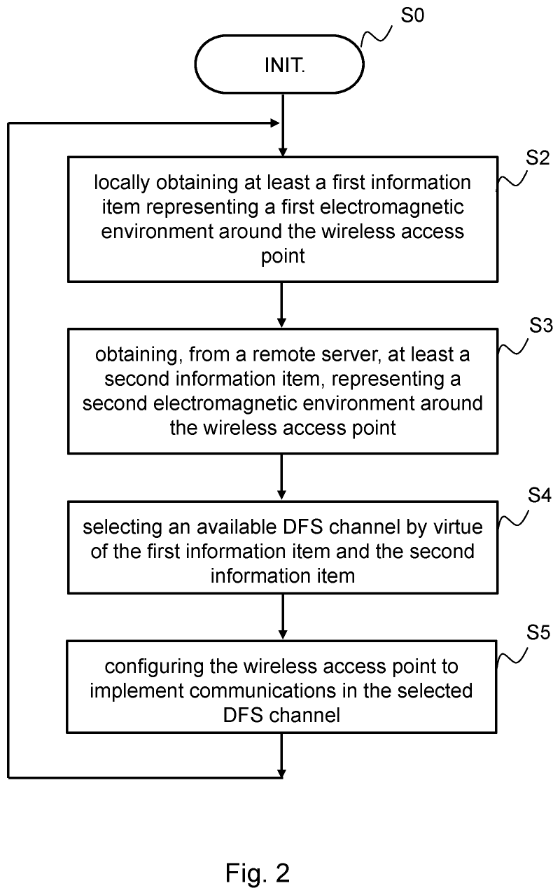

FIG. 2 is a flowchart representing the main steps of a method for selecting and allocating a DFS channel by a wireless access point device of the communication network 1. According to one embodiment of the invention, the method shown in this FIG. 2 is executed in each of the wireless access point devices of the communication network 1, that is in the wireless access point devices 10, 12 and 14.

A step S0 corresponds to a nominal operation of the various devices of the communication network 1 after an initialization of all the devices present in the network, for example, after they are respectively powered-up and after their respective configuration and self-test phases. In other words, all the devices shown in FIG. 1 coexist in the communication network 1 and implement required transmissions according to the specific operation of each mobile station, as well as the wireless access point devices 10, 12 and 14 of the communication network 1. At this stage, after having determined that a channel selection from among DFS channels is desirable or required for at least one of the wireless access point devices 10, 12, or 14, the method is initiated. It is possible to determine that a channel selection from a list of DFS channels is required, either since a user manually configures a wireless access point in the communication network 1, or since an automated method embedded in any of the wireless access points in the communication network 1 scans the channels in order to optimize their allocation. Throughout the remainder of the description of the method shown in FIG. 2, the example of selecting and allocating a DFS channel is described for the wireless access point 14 of the communication network 1, located in the third household from among the three households previously cited with reference to FIG. 1.

According to one embodiment, the wireless access point device 14, which must select a channel that is possibly already in use, uses internal resources to locally obtain at least a first information item representing a first electromagnetic environment around it, i.e. within range of it in terms of electromagnetic signal reception. Thus, during a step S2, the wireless access point device scans, for example, the DFS channel 100, selected by a user of the third household during a manual configuration of the wireless access point 14, for the purpose of checking whether signals representing the presence of a radar are detected on this DFS channel 100 (in the frequency band defining this DFS channel 100). According to one embodiment, and in the absence of detected radar signals, the wireless access point 14 consults an internal information table mentioning the last date (and time) on which a change in the status of the DFS channel 100 occurred. This reading allows it to obtain a second information item of the first electromagnetic environment around it, indicating, for example, that although no radar signal is detected at this stage, a change in occupancy status has taken place for this DFS channel 100 in the previous two hours, in the sense of the detection of a radar, which could therefore potentially indicate significant variability in the status of this channel in terms of occupancy by a radar. This information is such that it presumes that a radar present in this first electromagnetic environment around the wireless access point 14 could be activated shortly, which would then render the channel unusable for a connection from a station, such as, for example, a laptop 1412 that is commonly present in this household (the third household). In a step S3, the wireless access point 14 then sends a request to the remote server 1200, which centralizes a lot of information representing a second electromagnetic environment, such as, for example, an electromagnetic environment comprising the second and the third households, which are relatively close to each other. The request is transmitted in an HTTP format message, carried using a TCP communication protocol, from the wireless access point device 14 to the remote server 1200, which at this stage centralizes information concerning the occupancy of DFS channels in the environments of some or all of the wireless access points in the communication network 1. Upon receipt of this request for information concerning the occupancy of DFS channels around the wireless access point device 14 of the third household, the remote server 1200 identifies the geographical position of the third household from which the request originates, for example, with reference to its public IP address, and determines a geocode, the structure (for example, the length) of which indicates a size of an area of interest. The size of the area of interest affected by the request can be determined by a service operator, or even can be predetermined by the wireless access point device 14, for example. The remote server 1200 then scans its database with a view to extracting data relating to the occupancy of the DFS channels in the area located by the geocode, as well as in the adjacent areas (for example, eight areas, when the map is of a hierarchical tile type). In another example, the remote server 1200 is configured to determine coordinates according to a system such as the “Global Positioning System” or “GPS” (its acronym), and in particular is able to determine GPS coordinates of the wireless access point device 14, and is able to extract data relating to the occupancy of the DFS channels in the area located by these GPS coordinates, as well as in the adjacent areas that can be located by their GPS coordinates. The data extracted from the database by the remote server 1200 is then structured so as to provide information relating to the occupancy of the DFS channels in the area of interest of the wireless access point device 14. According to one embodiment of the invention, the information is transmitted as a series of data each comprising a timestamp, a geocode or even coordinates according to another type of positioning system, a channel number and a status representing the availability of the indicated channel (for example, 0 for unavailable and 1 for available).

According to an alternative embodiment, the status of a DFS channel comprises an availability index for this DFS channel, computed by the remote server 1200. For example, the availability index seen from the remote server 1200 is equal to 0.65, given the information available thereto, and independently of the absence of radar signal detection seen directly and locally from the wireless access point 14.

The transmitted information then forms a list of DFS channels comprising, for each of the channels, information representing its availability, in other words, an availability index for each of the accessible channels, or for part of the accessible channels, for the wireless access point device 14. For example, the information transmitted by the remote server 1200 to the wireless access point device 14 indicates that the DFS channel 104, neighbouring the DFS channel 100 in the same frequency band, has the highest availability index, and that its value is also the maximum availability value that can be reached, that is according to the example described, the index value for the DFS channel 104 is equal to 1. According to one embodiment, the remote server 1200 transmits related information to the wireless access point device 14 regarding the DFS channel 104 to the extent that the channel 104 has the highest availability index. This related information indicates, for example, that the DFS channel 104 has not been identified as being occupied by a radar for more than two consecutive years, in the geographical area of the third household, as well as in the adjacent geographical areas, such as, for example, an area comprising the nearby second household, that is, in other words, in the geographical area of the wireless access point device 14, as well as in the surrounding area. This information is therefore valuable in terms of the method for allocating the wireless access point device 14, since while this wireless access point device 14 is potentially capable of storing features relating to the electromagnetic environment within its range, it is not capable of storing features relating to the electromagnetic space outside its range.

With this information being available, the wireless access point device 14 then selects, in a step S4, according to the example described, the DFS channel 104, which appears to be most likely to be available and performs measurements on this DFS channel 104 before allocating it, or allocates the DFS channel 104 to communications, and then performs non-continuous measurements for the purpose of confirming its medium-term availability. If no radar signals are detected on the DFS channel 104, the wireless device 14 “confirms” the use of this DFS 104 channel for wireless transmissions, for example, in a residential setting, between the wireless access point 14 and a laptop, a smartphone or any other device for traditional domestic use, and then reconfigures or configures its circuits so as to use the DFS channel 104 for such transmissions, during a step S5.

According to one embodiment of the invention, the wireless access point device 14 transmits information to the central server 1200 notifying it of the use of the channel 104. Optionally, the wireless access point device 14 updates all the information available to it, in terms of channel occupancy and network availability in its surroundings, in the remote central server (SSID, BSSID, RSSI, number of connected stations, type of stations, for example).

According to an alternative embodiment, the wireless access point device 14 transmits, during an optional intermediate step (not shown in FIG. 2) between step S0 and step S2, information representing the occupancy of the channels and the availability of networks in its surroundings, in an ad hoc or more recurrent manner, so as to regularly assist the effort to centralize and pool information representing the electromagnetic environments of all the access points of the communication network 1, ideally, or at least a large number of them.

The set of hardware and software means implemented in each of the wireless access point devices 10, 12, and 14 is called “cloud agent” and the set of hardware and software means implemented in the central server 1200 is called “cloud platform”. In another example, the residential gateway to which the wireless access point device 14 is connected, as well as optionally other wireless access point devices and stations, comprises a cloud agent. This cloud agent is configured to communicate with the wireless access point device 14 and with the remote server 1200 and is configured to perform the steps of the method described in FIG. 2 instead of the wireless access point 14. This arrangement of the cloud agent in the residential gateway enables centralized management of the execution of the method described in FIG. 2 and also allows the complexity of the wireless access point device 14 to be reduced.

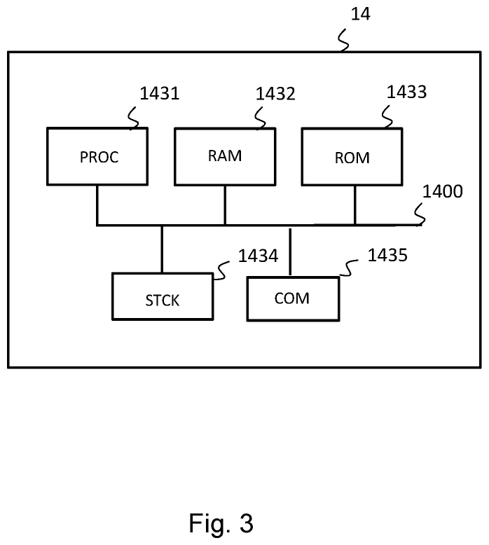

FIG. 3 schematically shows an example of the internal architecture of a wireless access point device to a communication network comprising a cloud agent. For illustrative purposes, FIG. 3 is considered to show an internal arrangement of the wireless access point device 14. It should be noted that FIG. 3 could also schematically show an example of a hardware architecture of a cloud agent type processing module included in the wireless access point 14 or even a home network gateway device comprising the wireless access point device 14, which comprises a cloud agent.

According to the example of a hardware architecture shown in FIG. 3, the wireless access point device 14 then comprises, connected by a communication bus 1400: a processor or CPU (“Central Processing Unit”) 1431; a RAM (“Random Access Memory”) 1432; a ROM (“Read Only Memory”) 1433; a storage unit such as a hard disk (or a storage medium reader, such as an SD (“Secure Digital”) card reader 1434; at least one communication interface 1435 enabling the wireless access point 14 to communicate with devices in the communication network 1, such as, for example, the access points 10 and 12 or even the remote server 1200.

The processor 1431 is capable of executing instructions loaded into the RAM 1432 from the ROM 1433, an external memory (not shown), a storage medium (such as an SD card), or a communication network. When the wireless access point device 14 is powered-up, the processor 1431 is able to read instructions from the RAM 1432 and execute them. These instructions form a computer program causing the processor 1431 to implement all or part of a method described with reference to FIG. 2 or the described alternative embodiments of this method.

All or part of the method described with reference to FIG. 2, or its described alternative embodiments, can be implemented in software form by executing a set of instructions using a programmable machine, for example, a DSP (Digital Signal Processor) or a microcontroller, or can be implemented in hardware form by a dedicated machine or component, for example, a Field-Programmable Gate Array (FPGA) or an Application-Specific Integrated Circuit (ASIC). In general, the wireless access point device 14 comprises electronic circuitry configured to implement the method described with reference thereto. Obviously, the wireless access point device 14 further comprises all the elements that are commonly present in a system comprising a control unit and its peripherals, such as, a power supply circuit, a power supply monitoring circuit, one or more clock circuits, a reset circuit, input/output ports, interruption inputs, bus drivers. This list is not exhaustive.

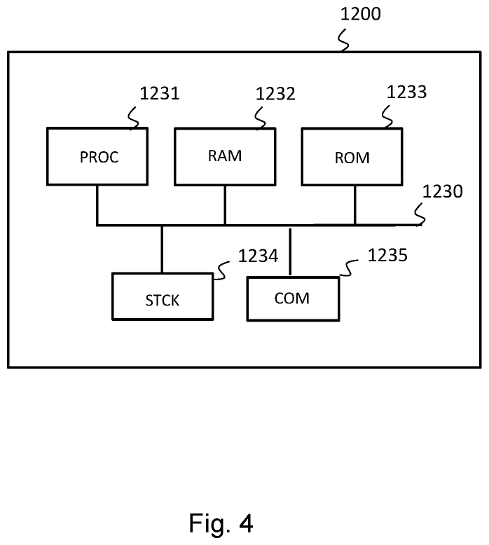

FIG. 4 schematically shows an example of the internal architecture of a server device in a communication network comprising a cloud platform. For illustrative purposes, FIG. 4 is considered to show an internal arrangement of the remote server device 1200. It should be noted that FIG. 4 could also schematically show an example of a hardware architecture of a cloud platform type processing module included in a remote server 1200 or even a network routing device comprising the remote server 1200, which comprises a cloud platform.

According to the example of a hardware architecture shown in FIG. 4, the remote server 1200 then comprises, connected by a communication bus 1230: a processor or CPU (“Central Processing Unit”) 1231; a RAM (“Random Access Memory”) 1232; a ROM (“Read Only Memory”) 1233; a storage unit such as a hard disk (or a storage medium reader, such as an SD (“Secure Digital”) card reader 1234; at least one communication interface 1235 allowing the remote server 1200 to communicate with devices present in the communication network 1, such as, for example, the wireless access point devices 10, 12 and 14 or the network gateways respectively embedded in or connected to these wireless access point devices.

The processor 1231 is capable of executing instructions loaded into the RAM 1232 from the ROM 1233, an external memory (not shown), a storage medium (such as an SD card), or a communication network. When the remote server 1200 is powered-up, the processor 1231 is able to read instructions from the RAM 1232 and to execute them. These instructions form a computer program causing the processor 1231 to implement part of a method described with reference to FIG. 2 or a method supplementing this method.

All or part of the method implemented by the remote server 1200, or its described alternative embodiments, can be implemented in software form by executing a set of instructions using a programmable machine, for example, a DSP (Digital Signal Processor) or a microcontroller, or can be implemented in hardware form by a dedicated machine or component, for example, a Field-Programmable Gate Array (FPGA) or an Application-Specific Integrated Circuit (ASIC). In general, the remote server 1200 comprises electronic circuitry configured to implement the described method in relation to itself, as well as to the wireless access point devices 10, 12, and 14. Obviously, the remote server 1200 further comprises all the elements commonly present in a system comprising a control unit and its peripherals, such as, a power supply circuit, a power supply monitoring circuit, one or more clock circuits, a reset circuit, input-output ports, interruption inputs, bus drivers. This list is not exhaustive.

According to one embodiment, the remote server 1200 with information relating to the operation of the various wireless access points of the communication network 1 can advantageously can monitor operations for gathering information from the wireless access points, to progressively and continuously refine the relevance of the mapping that is performed. Thus, the remote server 1200 can delegate analysis operations to wireless access point devices of the communication network that are seldom occupied or that are not occupied for performing transmissions. The remote server 1200 can also, for example, prepare, for each wireless access point device, a list of channels to be analyzed as a priority in order to complete the data already gathered with data that is being identified as missing or being deemed to be too old.

Finally, the remote server 1200 can collaborate with one or more other servers centralizing information, such as, for example, a server of an operator listing the most used channels in a communication network or a communication sub-network.

The invention is not limited solely to the previously described embodiments and examples, but relates to any method for selecting a channel using local information available within range of a wireless access point device comprising a cloud agent and also using information centralized and pooled by a cloud platform for selecting a channel and a configuration of the wireless access point device with a view to using this channel for wireless transmissions, with the channel potentially having priority for a third-party application, in particular due to a regulation.

1. Method for selecting a wireless communication channel between a wireless access point device of a communication network and a station, the method being executed in the wireless access point device of the communication network, the method comprising:
locally obtaining, from the wireless access point device, at least a first information item, representing a first electromagnetic environment within range of the wireless access point device;
obtaining, from a remote server, at least a second information item, representing a second electromagnetic environment around the wireless access point device;
selecting said communication channel by virtue of at least the first information item and the second information item;
configuring a radio interface of the wireless access point device to implement wireless communications with the station in the selected channel.

2. Method for selecting a wireless communication channel according to claim 1, wherein the first information item represents a frequency band and the second information item represents at least one level of availability of a wireless communication channel in the frequency band.

3. Method for selecting a wireless communication channel according to claim 1, wherein the second information item is included in a list of information relating to various channels and each representing at least one level of availability of a wireless communication channel from among a plurality of wireless communication channels in the frequency band.

4. Method for selecting a wireless communication channel according to claim 1, wherein obtaining the second information item from the remote server occurs following the transmission, by the wireless access point device, to the remote server, of a request issued in order to obtain at least the second information item.

5. Method for selecting a wireless communication channel according to claim 1, wherein the second environment is defined with reference to one or more location information items of the wireless access point device in a mapped data repository shared between the wireless access point device and the remote server.

6. Method for selecting a wireless communication channel according to claim 1, wherein at least one channel of the frequency band is defined as being primarily assignable for an application other than wireless communications.

7. Method for selecting a wireless communication channel according to claim 1, comprising at least one step of gathering information representing environments around a plurality of wireless access point devices comprising the wireless access point device and transmitting this information to the central server.

8. Method for selecting a wireless communication channel according to claim 7, comprising a plurality of steps of gathering information representing environments around a plurality of wireless access point devices comprising the wireless access point device, with at least part of the gathering steps being prior to the selecting step and part of the gathering steps being subsequent to the selecting step.

9. A wireless access point device of a communication network, the wireless access point device comprising electronic and/or radio circuits configured for:
locally obtaining, from the wireless access point device, at least a first information item, representing a first electromagnetic environment within range of the wireless access point device;
obtaining, from a remote server, at least a second information item, representing a second electromagnetic environment around the wireless access point device;
selecting the communication channel by virtue of at least the first information item and the second information item;
configuring a radio interface of the wireless access point device to implement wireless communications with the station in the selected channel.

10. A server in a communication network, the server comprising electronic and/or radio circuits configured for:
receiving, from at least one wireless access point device connected to the communication network, information representing one or more environments around one or more wireless access point devices comprising the wireless access point device;
sending, optionally in response to a request, at least one information item to a wireless access point device representing an electromagnetic environment around the wireless access point device.

11. A system in a communication network network comprising a wireless access point device according to claim 9 and a server in a communication network, the server comprising electronic and/or radio circuits configured for:
receiving, from at least one wireless access point device connected to the communication network, information representing one or more environments around one or more wireless access point devices comprising the wireless access point device;
sending, optionally in response to a request, at least one information item to a wireless access point device representing an electromagnetic environment around the wireless access point device.

12. An information storage medium comprising a computer program product that comprises program code instructions for executing the steps of the method according to claim 1, when the program is executed by a processor.

13. (canceled)
